(19) United States
(12) Patent Application Publication
(10) Pub. No.: US 2010/0051523 A1
(43) Pub. Date: Mar. 4, 2010

(54) LoweFlow filter wastewater treatment system

(76) Inventors: David Mark Lowe, Kenmore, WA (US); Richard D. Eldredge, Lake Stevens, WA (US)

Correspondence Address: David Mark Lowe, PO Box 82141, Kenmore, WA, 98028, US

(21) Appl. No.: 12/378,716

(22) Filed: Feb. 19, 2009

Related U.S. Application Data
(60) Provisional application No. 61/190,186, filed on Aug. 27, 2008.

(51) Int. Cl. B01D 35/157; B01D 35/22

(52) U.S. Cl. 210/106; 210/137

(57) ABSTRACT

The LoweFlow Filter wastewater treatment system is a recirculating filtering system intended to treat typical residential septic tank effluent. Septic effluent is continuously (or near continuously) dosed under pressure to the treatment media through pressure compensating drip irrigation emitters.

Wastewater trickles down through the media where it is attenuated through physical, chemical, and biological means. Treated wastewater or filtrate collected from the bottom of the recirculating filter returns to the recirculating tank, either by gravity flow or under pressure, through the flow splitter. During periods of low or no wastewater flow, a flow splitter will allow all of the filtrate from the treatment filter back into the recirculation tank. During periods of moderate or high wastewater flow, the flow splitter will allow all or a portion of the filtrate to be diverted for final disposal.

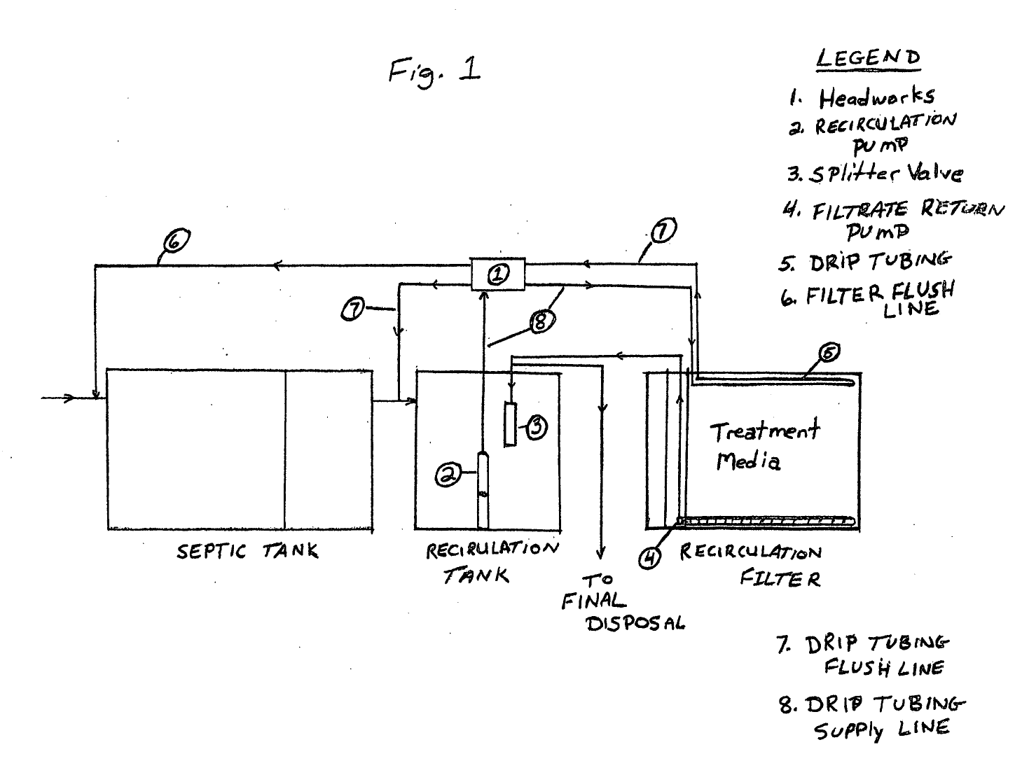

The LoweFlow Filter wastewater treatment system is a recirculating sand, gravel, or synthetic media filtering system intended to treat typical residential septic tank effluent. Septic effluent is continuously (or near continuously) dosed under pressure to the treatment media through pressure compensating drip irrigation emitters. The system is comprised of a septic tank, recirculation tank, recirculation filter, drip irrigation emitter network (or tubing), pump(s), an electrical control panel, a headworks (disk filter, pressure gauges, electrical and ball valves), and a flow splitter (see FIG. 1).

Septic tank effluent is collected in the recirculation tank, from which it is continually dosed by means of a pump to the top of the treatment media of the recirculating filter through pressure compensating drip emitters. Continuous dosing of diluted residential septic tank effluent through drip irrigation emitters provides a slow consistent application of liquid rich in organic material and pathogens over the treatment media. The slow discharge of effluent into the media creates a thin film of wastewater over the individual media particles as the liquid migrates to the bottom of the treatment unit. This allows for regular and continual contact of molecular oxygen, water, organic material, and bacteria. Treated wastewater or filtrate collected from the bottom of the recirculating filter returns to the recirculating tank, either by gravity flow or under pressure, through the flow splitter. During periods of low or no wastewater flow from the septic tank into the recirculation tank, the flow splitter will allow all or most of the filtrate from the treatment filter back into the recirculation tank. (By recirculating filtrate back into the recirculation tank, incoming septic tank effluent is diluted prior to being dosed to the filter). During periods of moderate or high wastewater flow, the flow splitter will allow all or a portion of the incoming filtrate to bypass the recirculation tank for final disposal.

Most all other sand, gravel, or synthetic media wastewater treatment systems are dosed intermittently, either a single pass or recirculated, and rely upon a repeat cycle timer and a pump to regulate the frequency and volume of the wastewater applied to the surface of the treatment media. The timers are set with specific on and off time intervals. The off times determine the number of doses over time and the on times determine the dose volume. In all cases, there are distinct dosing and resting periods to prevent overloading the media past the point of failure. Even in cases where drip irrigation tubing is used in treatment systems, very distinct dosing schedules are used. In recirculating sand and gravel filters as well as synthetic packed-bed-filters, repeat cycle timers are the traditional methodology for flow control.

FIG. 1

FIG. 1 indicates the overall view of the LoweFlow treatment system.

The septic tank receives wastewater from a building's plumbing drains. After the wastewater is settled, clarified effluent flows from the outlet of the septic tank to the recirculation tank. In the recirculation tank, septic tank effluent and filtrate from the recirculation filter are mixed, thereby diluting the septic tank effluent. This diluted mixture is continuously (or near continuously) dosed by the recirculation-pump (2), through the headworks (1) to the drip tubing containing pressure compensating drip emitters (5).

The pressure compensating emitters (5) regulate the flow into the recirculation filter media. As the flow of liquid migrates down through the treatment media, physical, biological, and chemical process are at work attenuating organic material, nitrogen compounds, and pathogens. The treated effluent is collected in the bottom of the filter and is pumped by the filtrate return pump (4) (or flow by gravity if the elevation between the bottom of the recirculation filter is higher than the splitter valve) to the splitter valve (3), located in the recirculation tank.

When the liquid level in the recirculation tank is low, all of the treated filtrate will return to be dosed again. When the liquid level in above the point at which the splitter valve (3) seats, all or most of the filtrate return liquid will be bypassed for final disposal.

1. The #1 claim is that continuous dosing of effluent in conjunction with pressure compensating drip irrigation emitters regulate the flow rate through the treatment filter, thereby preventing over taxing the treatment media and preventing failure.
